(19) United States
(12) Patent Application Publication
(10) Pub. No.: US 2013/0312008 A1
(43) Pub. Date: Nov. 21, 2013

(54) Integrated Network System

(71) Applicants: Johnathan J. PARK, Los Angeles, CA (US); John K. Park, Los Angeles, CA (US)

(72) Inventors: Johnathan J. PARK, Los Angeles, CA (US); John K. Park, Los Angeles, CA (US)

(21) Appl. No.: 13/474,023

(22) Filed: May 17, 2012

(51) Int. Cl. G06F 9/46

(52) U.S. Cl. 718/106

(57) ABSTRACT

An embodiment of the present invention establishes a neural network of handheld devices with a master server so that the master server may parcel out a large task into many smaller tasks to be assigned to one or more networked and subservient handheld devices. The handheld devices will then use its computing power to process the assigned smaller task and send the output to the master server for its compilation of the output data for producing an answer to the large task.

### BACKGROUND OF THE INVENTION

Although there are many handheld devices having great computing capacities, there is no active neural network of handheld devices that can access the unused computing power of the handheld devices. This is especially true when the latest smart phones have multi-core processing mode, such that each handheld devices is designed to a capacity of very complex functions and playing games, as well as accessing the world wide web through wireless network. Unfortunately, the users seldom, if at all, utilize the full capacity of the handheld devices in doing the routine functions, such as answering phone calls, and therefore has much unused capacity.

The current use of so many independent handheld devices is that each is able to perform one or more functions in receiving and making phone calls, taking pictures, playing music, downloading applications for its use, transmitting the result. With so many varieties of functions each handheld device can perform, with ever increasing speed, the internal computing capacity of the handheld device has increased greatly. One of the problems the inventors find is that each smart phone or a handheld device has great computing capacity, but its capacity is underutilized, if not sitting dormant the most of time.

Therefore, this invention is to establish a network of handheld devices with a master server so that the master server can establish a neural network of the handheld devices so the master server may utilize the dormant capacity of the network handheld devices, such as cell phones and handheld music players.

### SUMMARY OF THE INVENTION

This invention establishes a neural network of handheld devices with a master server so that the master server may parcel out a large task into many smaller tasks to be assigned to one or more networked and subservient handheld devices, wherein the handheld devices will use its computing power to process the assigned smaller task and send the output to the master server for its compilation of the output data for producing an answer to the large task.

An embodiment of the present invention may be an integrated network system having a master server and a plurality of handheld devices having an internal CPU and an associated RAM. The handheld devices may be operated independently of the master server using the internal CPU and the associated RAM for its independent functions, such as making and receiving phone calls, playing music, and using preloaded applications.

The handheld devices, however, do not use its full computing power performing these functions; therefore, these independent functions from the master server are performed through a first computing capacity with the rest of the internal computing capacity remaining dormant. This unused computing capacity, identified as a second computing capacity, can be used by the networked master server to do a task, whether the entire task or a part of a larger task which the master server will compile the data received from the second computing capacity to produce the result of the task.

In order for the master server to be able to access the networked handheld device, the handheld device is pre-programmed to be subservient to the master server and accept a command from the master server to do a task or a part of the task, while the handheld devices will continue the processing required to the routine tasks of the handheld device using the first computing capacity. Therefore, the master server will have control and access of the handheld devices' second computing capacity, so that the master server can literally have unlimited total computing power, limited only by the number of handheld devices networked to the master server. With the modern technology, due to the power of the master server and the number of smart phones and other handheld devices used all over the world, the total computing power of the master server may increase unlimitedly, through its wired, wireless, or phone connection system.

In a quick summary, the integrated network system will comprise of a master server with a plurality of handheld devices, wherein the handheld devices can be continuously or intermittently connected to the master server, or can be totally disconnected from the server. The handheld device as the ability to partition its total computing capacity to one or more computing capacity, whether it is compartmentalized using different set of hardware, using different part of a multi-core processing paths, or merely allocating predetermined capacity of the CPU or of the RAM, or other means to partition the capacity of the overall processing power.

The master server has a means, such as a task manager, for parceling out a project to a plurality of smaller tasks and has a means, such as a facilitator, for assigning the smaller tasks to one or more handheld devices to process one or more smaller tasks using the second computing capacity of the handheld devices. Moreover, the master server has a means, such as a receiver, for receiving a processed output from the handheld devices, and a means, such as a compiler, for compiling the outputs received from the handheld devices to provide a result to complete the project.

The master server may also have a means, such as a director, for variably allocating the second computing capacity from the overall computing capacity of the handheld device based on an independent non-subservient function of the handheld device. As an improvement to the invention, the director may allocate up to a predetermined amount of the total computing capacity of the handheld device as the second computing capacity based on an on-going varying processing need of an independent non-subservient function of the handheld device. In the later mode, the handheld device would not lack or become slow due to the subservient function demand from the master server.

As an alternate variation to the invention, this variably allocating the second capacity from the overall computing capacity of the handheld device means may be located in each handheld device, instead of the master server. Whether the director is located in the master server or in the handheld device, the director may be further comprised of a means, such as a supervisor, for monitoring and informing the varying need of the handheld device.

The integrated network system may also comprise of one or more workstations through with the task may be inputted into the main server, as well as displaying the task result. The task result may be displayed on a different workstation or even one of the handheld devices. Likewise, one of the handheld devices may be used to input the task to the main server, and the task result may be displayed on the handheld device that made the request, a workstation or even one of the other handheld devices.

When the handheld devices are comprised of cellular phones, it is preferable when the user can manually using an override switch (or other disconnecting means) or by a predetermined input to shut off the access from the master server or even from the integrated network. This function is especially valuable to ensure the user that no private information may be accessed by the master server or anyone connected to the integrated network. When such severance of link is desired the user can input a command to the handheld device and have the director disconnect the handheld device. Also, the director can monitor the status of the connection, and determine to disconnect the handheld device when it is disconnected from the master server. In addition, the handheld device may be programmed so that the director would disconnect the handheld device from the master server when the handheld device receives a phone call or otherwise requires the full access to its CPU's processing power.

Because the director may disconnect the handheld device with or without notifying the master server, when the handheld device is disconnected, whatever unfinished task the handheld device was assigned to would be rerouted to a different handheld device (or even to the master server or other network computers) so the overall task management by the task manager would be uninterrupted. Moreover, one of the functions of the director may be is to indicate to the handheld device when the handheld device is networked with the main server and therefore the handheld devices is utilized by the master server. This would ensure that the user of the handheld device may choose to disconnect from the network at any time. Alternately, the director may ask the user of the handheld device for a permission to access the unused computing power, and only with a permission from the user, the network may access the unused computing power.

One of the benefits of this integrated network system is that it utilizes the unused computing capacity that is already available to the businesses. Many businesses today purchase and provide the company phones to their workers for the work use. However, the businesses are unable to tap into this vast amount of computing capacities of the cell phones and other handheld devices, and sometimes forced to upgrade the master server. For example, using this invention, for a company that has a thousand employees with five hundred cell phones provided by the company, the company would be able to access up to (or even more with permission from the employees and associates) five hundred handheld devices, each having an advanced CPU such as multi-core technology having multiple processing routes. Therefore, it is believed that this integrated network system may be a good substitute to upgrading the master server whenever computing capacity needs to be increased. Because it may be such that the company may have to update the phones more readily, because of the new trend or new technology released by the phone companies and the employees would demand to always have the latest model, the company could provide the latest phones to the employees rather than upgrade the master server which only the limited number of employees would interact with.

Because the handheld devices can be connected to the master server through wireless communication system, mobile communication system, hard wire communication system (such as using the docks), and any combination thereof, the integrated network system may utilize even the handheld device that is on the other side of the globe. In addition, because the most users of the cellular phones do not really use their phone's full capacity, they may license its use in part to the companies they could trust so that the company would be subsidizing the phone use.

Although the computation speed of the cellular phones may be slower than the master server, when there are thousands connected, the computing power that can be access cannot be ignored. It is desirable that only related parties would access a certain network; however it is foreseeable that a networked company may share or even sell some of its unused computing power to others when the company can ensure the security of the servers. More, it is possible that a government may be able to access nearly unlimited computing power during a national crisis.

### BRIEF DESCRIPTION OF DRAWINGS

FIG. 1 shows a diagram of the integrated network according to an embodiment of the present invention.

FIG. 2 shows a diagram of the integrated network according to another embodiment of the present invention.

### DETAILED DESCRIPTION

An embodiment of the present invention establishes a neural network of handheld devices with a master server so that the master server may parcel out a large task into many smaller tasks to be assigned to one or more networked and subservient handheld devices. The handheld devices will then use its computing power to process the assigned smaller task and send the output to the master server for its compilation of the output data for producing an answer to the large task.

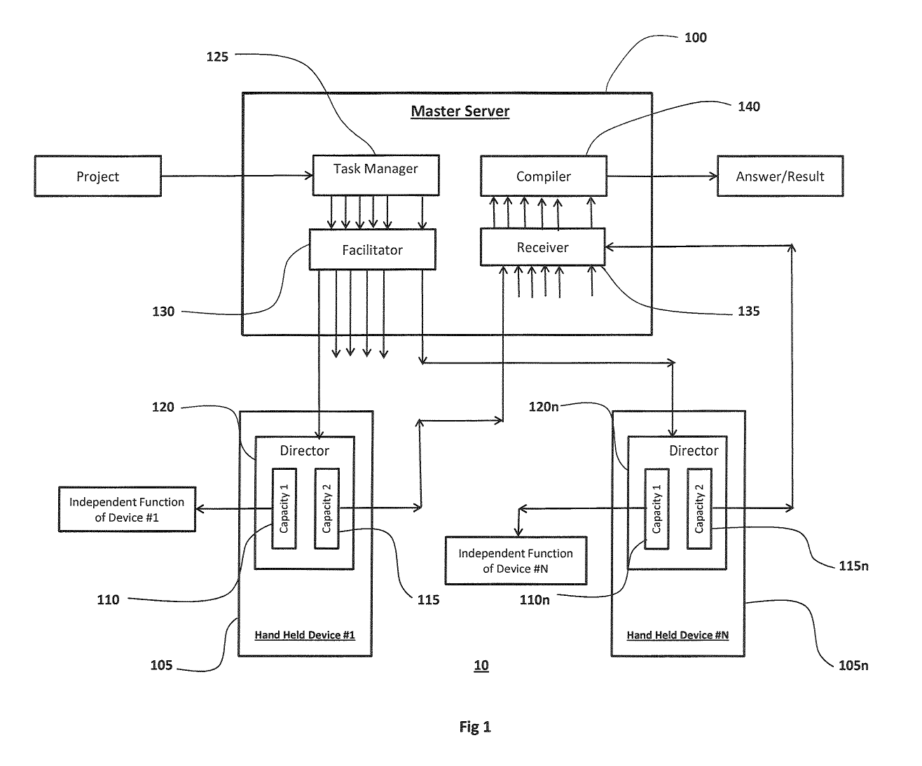

As shown in FIG. 1, the integrated network system 10 has a master server 100 and a plurality of handheld devices 105 through 105n linked to the master server. The master server may be used to network other fixed computers and workstations or used to solely integrate the handheld devices 105 of this invention, or any combination thereof.

The handheld devices 105, such as smart phones and MP3 players, are operated independently of the master server 100 using the internal CPU and the associated RAM for its independent functions, such as making and receiving phone calls, playing music, and using preloaded applications. The ideal handheld devices 105 are the smart phones with muti-core processing functions, but other handheld devices such as MP3 players and future cameras with powerful computing capability may be the handheld devices 105. The internal CPU may be any form of central processing unit, including but not limited to a socket type or an integrated unit into an internal logic system.

The modern smart phones have great computing capabilities, and a today's smart phone may pack computing power that is equivalent to a main frame from only ten years ago. Unfortunately, these handheld devices 105 are designed to function separately from one another and design to handle a peak computing load which the most handheld device may never experience. Therefore, these handheld devices do not use its full computing power the most of time, if not all the time.

In order to utilize the computing power of the handheld devices 105, the handheld devices may be assigned two or more internal computing capacities: a second computing capacity 110 (Capacity 1) and a second computing capacity 115 (Capacity 2). Although it is possible to segment the computing capacity even further, for this invention, all other segmentations will be considered as a part of the second computing capacity 115. However, as the handheld devices 105 are not limited to link with only a single master server, if there is a need for networking with a multiple networks, then the handheld devices 105 may be segmented into as many segmentations, such as Capacity 1 through Capacity n, to meet the need. For the convenience of the segmenting the computing capacities, each core of the multi-core processing path may be assigned, but the segmentation may actually segment the capacity such that a single core may be assigned to one or more segmentation for multitasking.

Upon segmentation, the second computing capacity 110 will be used for the independent functions of the handheld device 105, such as making and receiving phone calls, browsing the world wide web, or texting. The second computing capacity 115, which would have been left dormant during such a normal use of the handheld device 105, will now be available for a neural integrated network so that its master server 100 may access and use the second computing power of the handheld device 105 to do a task. Of course, a small task may be simply done by the master server 100, but when it would be ideal to have numerous computers work simultaneously to receive an answer quickly, it would be good for the master server 100 to break up or parcel the task into numerous smaller tasks and use what would have been unused computing power of the handheld devices 105 to simultaneously do the smaller tasks, then compile the outputs from the handheld devices 105 to compute the answer, the result, or the desired output for the task. Upon the answer, the final output may be made to a workstation or even to a handheld device 105 or any computer networked to the master server 100.

In this embodiment of the integrated network system, each handheld device 105 has a director 120 to variably allocate the second computing capacity 115 from the overall computing capacity of the handheld device 105 based on an independent non-subservient function of the handheld device 105. As an improvement to the invention, the director 120 may allocate up to a predetermined amount of the total computing capacity of the handheld device 105 as the second computing capacity 115 based on an on-going varying processing need of an independent non-subservient function of the handheld device 105. The director 120 may continuously communicate with the Master server 100 informing the allocated capacity of the second computing capacity 115.

The master server 100 has four basic components: a task manager 125, a facilitator 130, a receiver 135, and a compiler 140. Although each of the four components are shown within the box of the master server 100, it is very feasible and possible that each component may be only a function of the master server 100 within it, each component may be only a chip within the master server 100, each component may only be a software within the master CPU, or each component may be located outside the master server 100 but networking with the master server 100.

The master server 100 will receive an input of a project or a main task from the user. The task may be inputted by the user through a terminal attached to the master server 100 or even requested by one of the handhelds networked with the master server 100. Once the task is received by the master server 100, the task is routed to the task manager 125 that determines whether the task should be sent to one or more handheld devices 105. Upon the task manager's decision to send the task to the handheld devices 105, the task manager 125 will then parcel out the task to a plurality of smaller tasks and assigns the smaller tasks to one or more handheld devices 105 using the facilitator 130. The facilitator 130 thus assigns the smaller tasks according to the computing power available in the handheld devices 105 using the second computing capacity 115.

The handheld device 105 processes the smaller task received using the second computing capacity 115, and the sends its output to the facilitator 135 of the master server 100. The input from the facilitator 135 is compiled by the compiler 140 of the master server 100 which will then send out the final result to an output device, such as a monitor attached to the master server 100 or even to a remote handheld device.

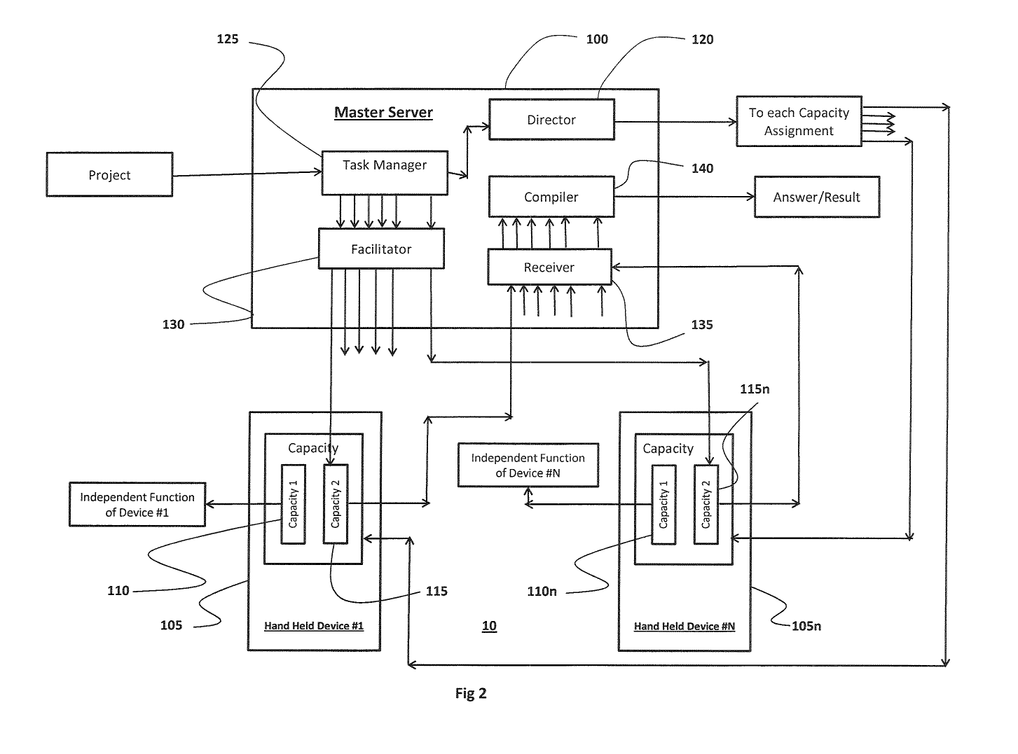

FIG. 2 shows an alternate embodiment in which the director 120 to variably allocate the second computing capacity 115 of the handheld devices 105 is located within the master server 100. The director 120 will then communicate with each handheld device 105 to monitor and assign the second computing capacity 115 to each handheld device 105.

Each element and each embodiment shown and described above may be implemented in various manners, including but not limited to, as a physical element, a separate software modules, as combination of hardware and software, or preprogrammed integrated circuits. For example, the task manager 125 may be a program containing lines of code that, when compiled, may be executed to adapt to function in one or more of the handheld devices 105. Another example is to have a step of the user verifying and authorizing the handheld's subservient function before the master server may access the computing power of the handheld device. Another variation is to have the handheld device giving a notice or an alarm to the user whenever the master server requests a task. Yet another variation is to have a downloadable app (an application downloaded from the handheld device service provider designed for the handheld device to a specific function) installed onto the handheld device so that the handheld device may become integrated according to this invention. And, another variation is to have an integration program installed onto the handheld device which allows the handheld device to be integrated into the network according to this invention.

Those skilled in the art will be able to implement the various modifications to this invention without departing from the spirit of the present invention. Therefore, it is intended that the present invention cover the modifications and variations given that they come within the scope of the appended claims and their equivalents.

What is claimed is:

1. An integrated network system comprising,
a master server,
a plurality of handheld devices having an internal CPU and an associated RAM, wherein the handheld device may be operated independently of the master server using the internal CPU and the associated RAM using a first computing capacity, and wherein the handheld device is designed to be partially subservient to the master server using a second computing capacity so that the master server may utilize unused processing power of the internal CPU and the associated RAM of the handheld device,
a task manager for dividing and parceling out a project to a plurality of smaller tasks,
a facilitator for assigning the smaller tasks to one or more handheld devices to process one or more smaller tasks using the second computing capacity of the handheld devices,
a receiver for receiving a processed output from the handheld devices, and
a compiler for compiling the outputs received from the handheld devices to provide a result to complete the project.

2. The integrated network system of claim 1 further comprising,
a director for variably allocating the second computing capacity from the overall computing capacity of the handheld device based on an independent non-subservient function of the handheld device.

3. The integrated network system of claim 2 wherein the director allocates up to a predetermined amount of the total computing capacity of the handheld device as the second computing capacity based on an on-going varying processing need of an independent non-subservient function of the handheld device.

4. The integrated network system of claim 3 wherein the director for varying the computing capacity of the second computing capacity is located in the handheld device.

5. The integrated network system of claim 4 wherein the director for varying the computing capacity of the second computing capacity is located in the master server.

6. The integrated network system of claim 5 further comprising one or more workstations to which the project may be inputted to the master server.

7. The integrated network system of claim 7 wherein the projected is inputted from one of the handheld devices connected to the master server or the workstation.

8. The integrated network system of claim 5 wherein the result is displayed on one of the handheld devices or to a workstation.

9. The integrated network system of claim 8 wherein the plurality of the handheld devices are cellular phones.

10. The integrated network system of claim 3 wherein the director disconnects the handheld device when the handheld device is disconnected from the master server or when the handheld device receives a phone call or otherwise requires the full access to its CPU's processing power.

11. The integrated network system of claim 10 wherein the facilitator reassigns any unfinished smaller tasks formerly assigned to the disconnected handheld device to a different handheld device connected to the network.

12. An integrated network system comprising,
a master server,
a plurality of handheld devices having an internal multi-core CPU and an associated RAM, wherein the handheld device may be operated independently of the master server using the internal CPU and the associated RAM using a first computing capacity, wherein the handheld device is designed to be partially subservient to the master server using a second computing capacity so that the master server may utilize unused processing power of the internal CPU and the associated RAM of the handheld device, and wherein the network system further comprising,
a task manager for dividing and parceling out a project to a plurality of smaller tasks,
a facilitator for assigning the smaller tasks to one or more handheld devices to process one or more smaller tasks using the second computing capacity of the handheld devices,
a receiver for receiving a processed output from the handheld devices,
a compiler for compiling the outputs received from the handheld devices to provide a result to complete the project, and
a director for variably allocating the second computing capacity from the overall computing capacity of the handheld device based on an independent non-subservient function of the handheld device, wherein the director allocates up to a predetermined amount of the total computing capacity of the handheld device as the second computing capacity based on an on-going varying processing need of an independent non-subservient function of the handheld device.

13. The integrated network system of claim 12 wherein the handheld device is connected to the master server through a wireless communication system.

14. The integrated network system of claim 13 wherein the handheld device is connected to the master server through a mobile communication system.

15. The integrated network system of claim 14 wherein the handheld device is connected to the master server through a combined network using the mobile communication system and a world wide web.

16. An integrated network system comprising,
a master server,
a plurality of handheld devices having an internal CPU and an associated RAM, wherein the handheld device may be operated independently of the master server using the internal CPU and the associated RAM using a first computing capacity, and wherein the handheld device is designed to be partially subservient to the master server using a second computing capacity so that the master server may utilize unused processing power of the internal CPU and the associated RAM of the handheld device,
a means for dividing and parceling out a project to a plurality of smaller tasks,
a means for assigning the smaller tasks to one or more handheld devices to process one or more smaller tasks using the second computing capacity of the handheld devices,
a means for receiving a processed output from the handheld devices,
a means for compiling the outputs received from the handheld devices to provide a result to complete the project, and
a means for variably allocating the second computing capacity from the overall computing capacity of the handheld device based on an independent non-subservient function of the handheld device.

17. The integrated network system of claim 16 wherein the director allocates up to a predetermined amount of the total computing capacity of the handheld device as the second computing capacity based on an on-going varying processing need of an independent non-subservient function of the handheld device.

18. The integrated network system of claim 17 wherein the director disconnects the handheld device when the handheld device receives a phone call or otherwise requires the full access to its CPU's processing power.

19. The integrated network system of claim 18 wherein the facilitator reassigns any unfinished smaller tasks formerly assigned to the disconnected handheld device to a different handheld device connected to the network.

20. The integrated network system of claim 17 wherein a downloadable app or an integration program installed onto the handheld device allows the handheld device to be integrated into the network.
